(19) United States
(12) Patent Application Publication
(10) Pub. No.: US 2019/0205906 A1
(43) Pub. Date: Jul. 4, 2019

(54) INFORMATION SYSTEM, ELECTRONIC DEVICE, COMPUTER READABLE MEDIUM, AND INFORMATION PROCESSING METHOD

(71) Applicant: ALIBABA GROUP HOLDING LIMITED, George Town (KY)

(72) Inventor: Tianmin LI, Hangzhou (CN)

(21) Appl. No.: 16/234,354

(22) Filed: Dec. 27, 2018

(30) Foreign Application Priority Data
Dec. 28, 2017 (CN) 201711457255.0

(51) Int. Cl. G06Q 30/02

(52) U.S. Cl. CPC G06Q 30/0202; G06Q 30/0201

(57) ABSTRACT

Embodiments of the disclosure provide an information system, a method for generating shopping information of a store consumer, and a non-transitory computer readable medium. The information system can include a memory storing a set of instructions; and at least one processor, configured to execute the set of instructions to cause the system to perform acquiring a first human physiological characteristic of a store consumer; generating at least one associated consumers corresponding to the store consumer based on the first human physiological characteristic; and generating demand preference for the consumer based on historical data of the at least one associated consumer.

### CROSS REFERENCE TO RELATED APPLICATION

The disclosure claims the benefits of priority to Chinese application number 201711457255.0, filed Dec. 28, 2017, which is incorporated herein by reference in its entirety.

### BACKGROUND

Customer relationship management (CRM) refers to a management manner in which information technologies and Internet technologies are used to coordinate interactions between a provisioner and a consumer (e.g., a client) during marketing and services to improve the provisioner. The intention is to provide innovative and personalized interactive services to consumers. CRM is embodied by software systems that analyze market, consumer, service, and application support by means of computer automation. The goal is not only to attract new consumers, retain regular consumers, and convert existing consumers into loyal consumers, but also to look for new market channels necessary for expansion and to improve values, satisfaction and loyalty of consumers.

With the continuous development of mobile network technologies, CRM has entered a mobile era. For example, functions such as consumer resource management, consumer service management, and routine affair management are migrated to mobile terminals, thereby achieving the migration of CRM to mobile terminals, which significantly expands the range of CRM applications. From the perspective of a business, however, refined management performed on consumers is still relatively rough during the processes of consumer resource management and consumer service management. In particular, there is a lack of consumer management based on accurate consumer identification.

### SUMMARY OF THE DISCLOSURE

The present application provides an information system to address the defect of the prior art that there is a lack of consumer management based on accurate consumer identification.

The present application simultaneously relates to an electronic device, a computer readable medium, and an information processing method.

Embodiments of the disclosure provide an information system. The information system can include: a memory storing a set of instructions; and at least one processor, configured to execute the set of instructions to cause the system to perform acquiring a first human physiological characteristic of a store consumer; generating at least one associated consumer corresponding to the store consumer based on the first human physiological characteristic; and generating demand preference for the consumer based on historical data of the at least one associated consumer.

Embodiments of the disclosure further provide a method for generating information of a store consumer. The method can include: acquiring a first human physiological characteristic of the store consumer; generating at least one associated consumer corresponding to the store consumer based on the first human physiological characteristic; and generating demand preference for the consumer based on historical data of the at least one associated consumer.

Embodiments of the disclosure also provide a non-transitory computer readable medium that stores a set of instructions that is executable by at least one processor of a computer system to cause the computer system to perform a method for generating information of a store consumer. The method can include: acquiring a first human physiological characteristic of the store consumer; generating at least one associated consumers corresponding to the store consumer based on the first human physiological characteristic; and generating demand preference for the consumer based on historical data of the at least one associated consumer.

### BRIEF DESCRIPTION OF THE DRAWINGS

FIG. 1 is a schematic diagram of an information system, according to embodiments of the disclosure.

FIG. 2 is a schematic diagram of an implementation scenario, according to embodiments of the disclosure.

FIG. 3 is a schematic diagram of another implementation scenario, according to embodiments of the disclosure.

FIG. 4 is a schematic diagram of an electronic device, according to embodiments of the disclosure.

FIG. 5 illustrates a method for generating consumer information, according embodiments of the disclosure.

FIG. 6 illustrates a method for further generating consumer information, according to embodiments of the disclosure.

### DETAILED DESCRIPTION

Many specific details are described below to facilitate a thorough understanding of the present application. However, the present application can be implemented in many other manners that are different from the description herein, and a person skilled in the art can make similar variations without departing from the essence of the present application. Therefore, the present application is not limited by the specific implementation disclosed below.

The disclosure provides an information system, an electronic device, a computer readable medium, and an information processing method, which will be described in detail below, one by one, with reference to the accompanying drawings of embodiments provided in the disclosure. The information system can acquire the first human physiological characteristic of the consumer via the first characteristic acquiring module, performs accurate identification on the consumer according to the first human physiological characteristic via the consumer identifying module, and helps the provisioner to provide pertinent services to consumers based on the benchmark identification, thereby improving the consumer service level of the provisioner and offering high quality service experience to consumers.

An information system according to embodiments of the disclosure is provided.

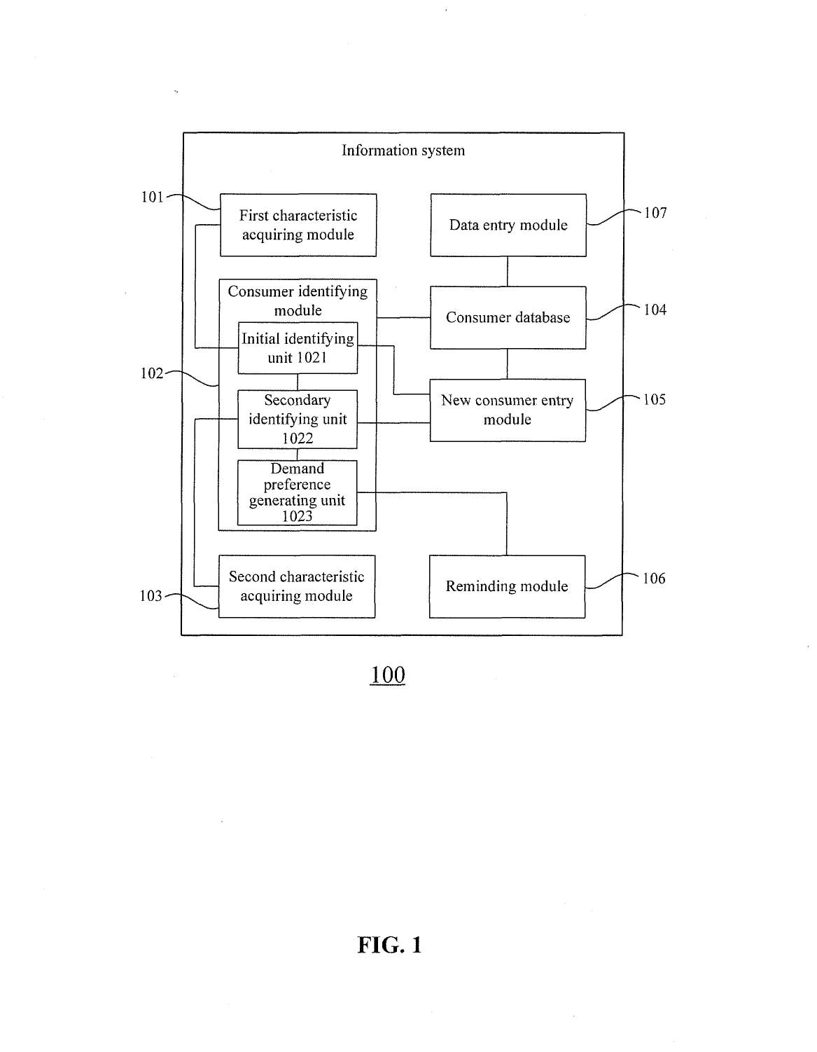

The information system can be used to assist offline stores in consumer management and maintenance, so as to improve the service quality of the stores and improve the consumer experience of services of the offline stores. FIG. 1 is a schematic diagram of an information system 100, according to embodiments of the disclosure. Information system 100 can include a first characteristic acquiring module 101 and a consumer identifying module 102.

First characteristic acquiring module 101 can be configured to acquire a first human physiological characteristic of a store consumer and upload the first human physiological characteristic to the consumer identifying module 102. The first human physiological characteristic can include at least one of face characteristics, voiceprint characteristics, gait characteristics, fingerprint characteristics, and physique characteristics (e.g., weight, height, body proportions, etc.). Moreover, the first human physiological characteristic can also be a combination of multiple human physiological characteristics from the above human physiological characteristics, or other human physiological characteristics that can be used to differentiate a consumer (e.g., customer).

An offline store may provide at least one camera at the door and inside the store. However, most of the cameras are provided for security purpose. The first characteristic acquiring module 101 in the present embodiment can be embodied based on a camera provided by the store. To rapidly identify whether the consumer is a historical consumer of the store, the first human physiological characteristic of the consumer (e.g., a face image) can be collected when the consumer enters the image collection range of the first camera of the store. The camera is not limited to the one provided at the store door, the first human physiological characteristic (e.g., the face image) can also be collected with a camera provided inside the store after the consumer enters the store.

Consumer identifying module 102 can be configured to identify a historical consumer corresponding to the consumer according to the first human physiological characteristic and generate demand preference of the consumer with respect to the store based on historical data of the historical consumer. Consumer identifying module 102 can include an initial identifying unit and a demand preference generating unit. The initial identifying unit can be configured to determine whether the store has a historical consumer having a similarity with the first human physiological characteristic satisfying a similarity threshold. If the store has a historical consumer having a similarity with the first human physiological characteristic, the initial identifying unit can make the consumer a historical consumer, and run the demand preference generating unit. The demand preference generating unit can be configured to acquire the historical data of the historical consumer and generate demand preference of the consumer with respect to the store based on the historical data.

It is appreciated that, the historical data can includes consumer data of the consumer at the store. For example, the consumer data of the consumer at the current store can include basic information and consumption information of the consumer. The basic information can include age information and educational background information of the consumer, and the consumption information can include consumption type, consumption credits, consumption points, and consumer consumption rating. Moreover, the historical data can further include consumer data from a data source with which the store has information exchange. For example, the current store is an offline store, and consumer data of an online store of the offline store can also be used as the historical data of the store. Alternatively, when the current store supports scan-to-pay, the consumer payment data accumulated from payment operations by consumers through third-party payment software can also be used as the historical data of the current store. In another example, when an online store of the current store performs payment operations using third-party payment software, the consumer payment data of the online store accumulated by the third-party payment software can also be used as the historical data of the current store.

It is appreciated that the consumer determined by consumer identifying module 102 may be the actual consumer, or may be a similar consumer with external physiological characteristics, such as face characteristics, voiceprint characteristics, gait characteristics, fingerprint characteristics, and/or physique characteristics, that are similar to those of the actual consumer. Thus, the consumer determined by consumer identifying module 102 may be referred to as an associated consumer, which can be the actual consumer or a similar consumer. To further determine whether the associated consumer is an actual consumer or a similar consumer with similar external physiological characteristics, an offline verification may be further provided, such that service personnel in an offline store determines whether the associated consumer is the actual consumer by active asking or observation.

In addition, an identification operation may be further performed to determine whether the associated consumer is the actual consumer. In some embodiments, the information system can further include a second characteristic acquiring module 103 configured to acquire a second human physiological characteristic of the consumer and upload the second human physiological characteristic to consumer identifying module 102. The second human physiological characteristic can include at least one of voiceprint characteristics, iris characteristics, and fingerprint characteristics. Furthermore, the second human physiological characteristic can also be a combination of multiple human physiological characteristics from the above human physiological characteristics, or other human physiological characteristics that can be used to differentiate a consumer. After entering a store, a consumer may talk to service personnel in the store (e.g., a service agent), and therefore the second human physiological characteristic of the consumer may be collected by a terminal device carried by the service agent in the store. For example, voiceprint information of the consumer may be collected by a cell phone carried by the service agent. Moreover, the second human physiological characteristic of the consumer can also be collected by a sensor for collecting the second human physiological characteristic that is provided by the store.

Thus, consumer identifying module 102 can further identify a historical consumer corresponding to the consumer according to the first human physiological characteristic and the second human physiological characteristic and can generate demand preference of the consumer with respect to the store based on historical data of the historical consumer at the store. For example, consumer identifying module 102 can include an initial identifying unit 1021, a secondary identifying unit 1022, and a demand preference generating unit 1023.

Initial identifying unit 1021 can be configured to determine whether the store has a historical consumer having a similarity with the first human physiological characteristic satisfying a first similarity threshold. If the store has the historical consumer having a similarity with the first human physiological characteristic satisfying the similarity threshold, initial identifying unit 1021 can run secondary identifying unit 1022.

Secondary identifying unit 1022 can be configured to determine whether the similarity in the second human physiological characteristic between the consumer and the historical consumer satisfies a second similarity threshold. If the similarity in the second human physiological characteristic between the consumer and the historical consumer satisfies the second similarity threshold, secondary identifying unit 1022 can make the consumer a historical consumer corresponding to the consumer at the store, and run demand preference generating unit 1023.

Demand preference generating unit 1023 can be configured to acquire the historical data of the historical consumer at the store and generate demand preference of the consumer with respect to the store based on the historical data.

Through the above verification of the first human physiological characteristic and the second human physiological characteristic, consumer identifying module 102 can determine whether the associated consumer is the actual consumer. If there is one and only one determined associated consumer corresponding to the consumer, the associated consumer may be determined to be the consumer. To be more accurate, an offline verification step may be further added, such that service personnel in an offline store determines whether the associated consumer is the consumer through active asking or observation. In the case where there is a plurality of determined associated consumers corresponding to the consumer, verification may be further conducted through an offline verification step, such that service personnel in an offline store determines which one of the plurality of associated consumers is the consumer through active asking or observation. In some embodiments, each of the plurality of associated consumers has a similarity with the consumer, and one associated consumer may have a highest similarity. For example, one of the associated consumers corresponding to the consumer A has a similarity greater than 95%, while the similarities of the other associated consumers are below 10%. The associated consumer having the highest similarity can be determined to be the consumer.

Furthermore, the information system can further include a consumer database 104 configured to store the first human physiological characteristic, the second human physiological characteristic of the consumer, and the historical data of the historical consumer. Therefore, the demand preference generating unit can acquire the historical data of the historical consumer at the store from consumer database 104. In some embodiments, consumer database 104 can be configured flexibly according to actual needs. For example, for stores with a relatively small number of consumers, a consumer database can be created for each store locally to maintain respective consumer data. For stores with a relatively large number of consumers or stores sharing consumer data among one another, an online shared consumer database can be created to provide online maintenance of consumer data for all stores, and each store can submit and access consumer data via a data interface provided by the online shared consumer database. Consumer data can also be stored in a remote cloud storage. For businesses with mass consumer data, this manner has significant advantages either from the perspective of storing the consumer data or from the perspective of subsequent processing and calculation on the consumer data.

In some embodiments, the associated consumer can include the historical consumer determined according to the first human physiological characteristic and/or the second human physiological characteristic. The associated consumer can further be associated with, based on determining the consumer, a historical consumer having age information and educational background information that are similar to those contained in the historical data of the consumer. For example, a consumer having similar age or identical educational background as the current consumer is treated as an associated consumer of the current consumer, and a historical consumer having consumption type, consumption credits, consumption points, and consumer consumption rating that are similar to those contained in the historical data of the consumer, such as a consumer having similar consumption records, consumption abilities, or consumption-related big data characteristics (e.g. the Taoqi Value) as those of the current consumer, is treated as an associated consumer of the current consumer. Since these associated consumers have similarity in a dimension with the consumer, the historical data of these associated consumers can be used as a basis for recommendations made to the consumer, such that recommendations can be made to the consumer according to a more comprehensive and more personalized demand preference.

In addition to the above described implementation manners, a consumer of the store can also be identified in other manners. In some embodiments, a consumer can be identified by detecting a terminal device carried by the consumer of the store. For example, a terminal device detecting module can be configured in the information system to detect and acquire a device identifier of a terminal device carried by the consumer of the store and upload the device identifier to consumer identifying module 102. And after the upload to consumer identifying module 102, the consumer identifying module can identify the terminal device carried by the consumer of the store through a terminal device identifying unit provided in consumer identifying module 102. If an identifying result is that the terminal device has been recorded in the past, the consumer carrying the recorded terminal device can be determined the historical consumer and the secondary identifying unit can further perform accurate identification on the historical consumer.

It is appreciated that not every consumer is a historical consumer who has visited the store, and it is inevitable that there are some new consumers coming to the store. In such scenarios, the information system can further include a new consumer entry module 105, which is configured to enter consumer data of a new consumer in consumer database 104. For example, new consumer entry module 105 can store the first human physiological characteristics and the second human physiological characteristics of the consumer in consumer database 104.

In some embodiments, when a consumer enters the store, the initial identifying unit provided above determines whether the store has a historical consumer having a similarity in the first human physiological characteristic with the consumer satisfying a first similarity threshold. If the store has no such a historical consumer, it indicates that the consumer is a new consumer. New consumer entry module 105 can enter relevant data of the consumer in consumer database 104. If the store has the historical consumer, it can be determined that the consumer has visited the store in the past and the secondary identifying unit can further determine whether a similarity in the second human physiological characteristic between the consumer and the historical consumer satisfies a second similarity threshold. If the similarity in the second human physiological characteristic satisfies the second similarity threshold, it indicates that the consumer is a historical consumer of the store and visited the store in the past. Then, the demand preference generating unit can acquire historical data of the consumer at the store from the consumer database 104 and generate demand preferences of the consumer with respect to the store based on the historical data. The demand of the consumer when visiting the store is analyzed and predicted to generate demand preference of the consumer with respect to the store. If the similarity in the second human physiological characteristic fails to satisfy the second similarity threshold, it indicates that the consumer is a new consumer and has not visited the store. The new consumer entry module 105 can enter relevant data of the consumer in the consumer database 104.

Furthermore, for new consumers with no historical data, associated consumers having corresponding relationships with these new consumers can be determined based on the collected data of the new consumers. For example, an associated consumer having similar human physiological characteristics (gender, appearance, weight, age, body proportions, etc.) as those of the new consumer, an associated consumer having similar dressing style as that of the new consumer, and the like can be determined. Since these associated consumers have similarity in a dimension with the consumer, the historical data of these associated consumers can be used as a basis for recommendations made to the new consumer, such that in the case of no historical data, personalized recommendations can be made at the first time. The satisfaction of the consumer can be improved.

Furthermore, a reminder to the store can be further made based on the demand preference of the consumer with respect to the store. In some embodiments, a reminding module 106 provided in the information system can generate this reminder. Reminding module 106 can receive the demand preference of the consumer with respect to the store issued by consumer identifying module 102, and sends a reminder based on the demand preference. For example, reminding module 106 can be embodied based on a terminal device carried by service personnel assigned to the consumer, and reminding module 106 can also be embodied based on an audio playing device carried by the service personnel. For example, a smart phone of a service agent serving the current consumer in the store sends text, audio, image or video reminding information to the service agent, such that the service agent serving the current consumer is reminded of the demand information of the current consumer with respect to the store, which enables the service agent to provide better service to the current service agent.

Moreover, the information system can further include a data entry module 107 configured to acquire consumer data of the consumer with respect to the store, and store the consumer data in consumer database 104 and treat the consumer data as a part of the historical data of the consumer. In some embodiments, the data entry module can be embodied based on a terminal device carried by service personnel assigned to the consumer, and/or the data entry module can be embodied based on an audio collecting device carried by the service personnel. For example, a service agent of the store inputs relevant info nation of a consumer via a cell phone carried thereby, or the service agent records voiceprint information of the consumer via an audio collecting device carried thereby.

In some embodiments, stores can install their respective Consumer Relationship Management (CRM) systems, and all consumer data of the stores can be maintained and managed by the CRM systems. Therefore, to make the information system according to the disclosure to be compatible with an information system (e.g., the CRM system) installed at a store, a data interface module can be provided for the information system. The data interface module can be configured to connect with a CRM system currently installed at the store and acquire historical data of the historical consumer of the store from the CRM system. For example, when the above demand preference generating unit is acquiring historical data of the current consumer at the store, it acquires the historical data of the current consumer at the store from the CRM system via the data interface module. In addition, the information system and the CRM system can be integrated, as long as the integrated system can achieve equivalent effects to those of the information system and the CRM system.

In some embodiments, consumer identifying module 102 can be disposed in a cloud computing environment. For example, functions of consumer identifying module 102 are packaged as a cloud service for consumer identification (consumer identification cloud service). An offline store may need to upload the first human physiological characteristic and second human physiological characteristic of the consumer to the consumer identification cloud service. For example, the information system of the offline store can configure a first upload path for first characteristic acquiring module 101 to upload the first human physiological characteristic to the consumer identification cloud service and a second upload path for second characteristic acquiring module 103 to upload the second human physiological characteristic to the consumer identification cloud service. The information system can further perform consumer identification processing and calculation by the consumer identification cloud service, and obtain an identification result. The offline store can obtain the identification result of consumer identification by accessing the consumer identification cloud service through an access address.

With the above manner of consumer identification cloud service, a small store may not have to provide dedicated collection apparatuses, but may collect the first human physiological characteristic using existing cameras in the store and collect the second human physiological characteristic using terminal devices carried by sales people of the store. Meanwhile, the store may not have to locally provide a device required for consumer identification processing and calculation. For offline small stores (e.g., chain stores), data sharing can be achieved for these stores through the consumer identification cloud service, making it unnecessary for the stores to transmit data to each other for sharing data. Meanwhile, personalized consumer identification cloud services can be custom-made according to actual business needs, leading to more abundant functions.

In addition to the above embodiments of consumer identifying module 102 using the consumer identification cloud service, consumer identifying module 102 can also be embodied by means of application programs. For example, the consumer identifying module 102 can be packaged into an application (APP) running on a terminal device. After first characteristic acquiring module 101 collects the first human physiological characteristic of the consumer and second characteristic acquiring module 103 collects the second human physiological characteristic of the consumer, consumer identification is performed based on the computing resources of the terminal device. Similarly, functional modules for implementing above new consumer entry module 105, reminding module 106 and data entry module 107 can be correspondingly added in the APP. In another example, the APP is installed on terminal devices carried by sales people of the store, and sales people of the store can have corresponding authorities. For example, a regular service agent can enter related information of a new consumer of the store via the APP, and a manager-level service agent can assign a regular service agent to provide services to a consumer entering the store. In such an implementation manner, it only requires to install an APP on a terminal device, leading to simple and convenient implementation.

The technical effects achieved by the method according to embodiments of the disclosure can include predicting the consumer's potential expectation without the consumer proactively explaining his/her own demand when a consumer enters a store, sending prompt information to sales people's devices to assist the sales people in providing corresponding recommendations to the consumer, and the like. The interaction efficiency between the sales people and the consumers can be improved, the communication time can be reduced, and the service efficiency can be improved.

The information system will be further described below with reference to two scenarios.

In a first scenario, consumer A is decorating the house lately and needs to select suitable decoration materials, such as floor, underfloor heating equipment, bathroom appliances, and kitchen appliances, from a market of construction materials. Therefore, Consumer A would go to stores of construction materials in the market of construction materials every weekend to compare required decoration materials. With intelligent toilets as an example, Consumer A may compare the desired brands over and over for many times. He goes to stores that sell toilets not just once, but many times before ultimately deciding on a store to purchase an intelligent toilet. This is a rough flow typically followed by the consumer to pick decoration materials.

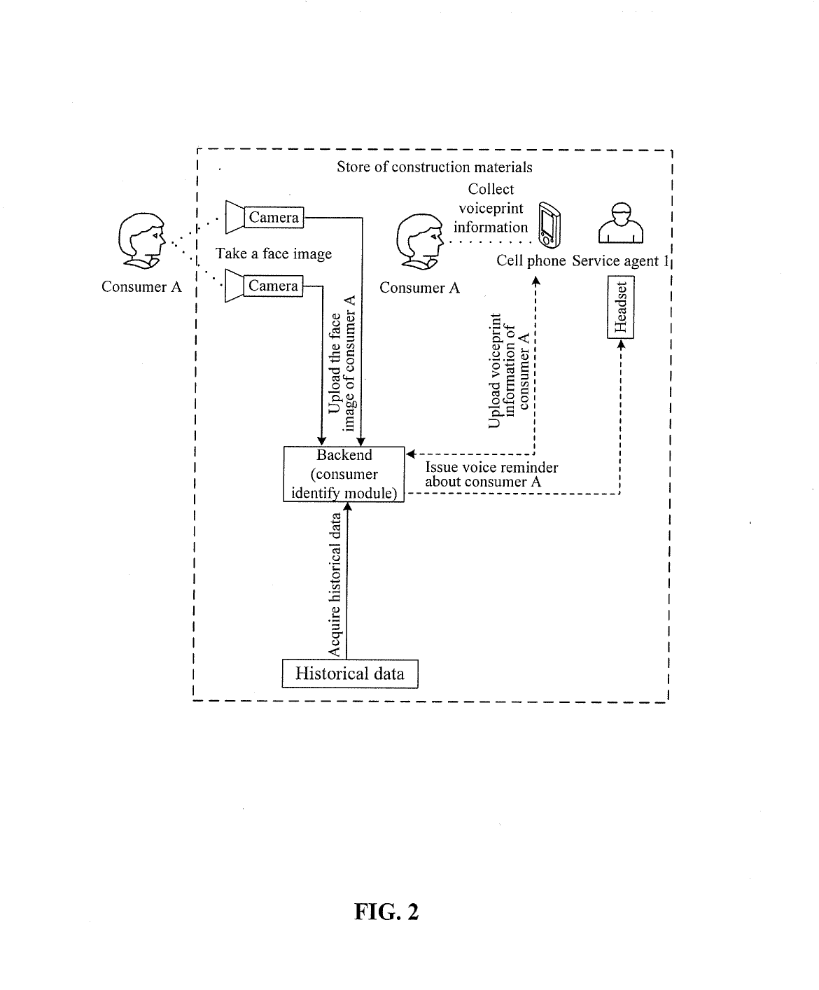

As shown in FIG. 2, when Consumer A enters a store of construction materials, the first human physiological characteristic of Consumer A (e.g., a face image) can be taken by first characteristic acquiring module 101 (e.g., a camera installed at the door of the store of construction materials), and the face image of Consumer A can be uploaded to the backend (e.g., in consumer identifying module 103). Upon receiving the face image of Consumer A, the backend compares the face image of Consumer A with face images of historical consumers of the store of construction materials and determines similarity therebetween. If the similarity between the face image of a historical consumer and the face image of Consumer A satisfies (e.g., greater than) a threshold (e.g., such as 80%), it can determine whether Consumer A and the historical consumer are the same consumer.

After Consumer A enters the store of construction materials, a service agent 1 of the store of construction materials can provide shopping guidance for Consumer A. During the guide, voiceprint information of Consumer A can be collected using a cell phone (e.g., using the first characteristic acquiring module 101) carried by the service agent 1, and the collected voiceprint information can be uploaded to the backend. The backend compares the voiceprint information of Consumer A with the voiceprint information of the historical consumer determined according to the above face image identification. If the similarity in voiceprint information between the two satisfies (e.g., greater than) a threshold (e.g., such as 90%), it is determined that Consumer A is a historical consumer of the current store of construction materials. In other words, it is determined that Consumer A has visited the current store of construction materials before.

Subsequently, the backend notifies the service agent 1 via a voice prompt of the historical data of Consumer A at the store of construction materials. The service agent 1 can receive, via a headset, the voice prompt of the historical data of Consumer A at the store of construction materials, including the name of Consumer A and key demand of the last visit. After receiving the voice prompt, the service agent 1 can recommend a desired intelligent toilet to Consumer A. For example, the service agent 1 can tell Consumer A, “Mr. x, how about this intelligent toilet you considered last time? It was 7235 Yuan last time, but we are having a promotion lately. If you buy today, you can have this discount.” Consumer A would certainly be impressed by the accurate and great memory of the service agent 1 and have a better shopping experience

Moreover, when an identification result at the backend indicates that Consumer A is a historical consumer of the store of construction materials, the backend can analyze the historical data of Consumer A at the store of construction materials to generate demand preference of Consumer A at the store of construction materials. If the historical data of Consumer A includes the brand, model and price of an intelligent toilet selected by Consumer A last time at the store of construction materials, then the demand preference of Consumer A is generated based on the historical data, and the demand preference may include the intelligent toilet selected by Consumer A last time, intelligent toilets of the same brand and at similar price levels, and intelligent toilets of different brands and at the same price level. After the demand preference is generated, the service agent 1 is reminded, via the headset, of the demand preference of Consumer A. Furthermore, the cell phone of the service agent 1 can receive the demand preference of Consumer A pushed by the backend, thereby facilitating the service agent 1 to provide better shopping experience to Consumer A.

If an identification result at the backend indicates that Consumer A is not a historical consumer of the store of construction materials, corresponding historical data records will be created for the new Consumer A, and the face image of Consumer A collected by the camera and the voiceprint information of Consumer A collected by the cell phone of the service agent 1 can be saved as the historical data; meanwhile, more accurate information of Consumer A can be collected by a recording device disposed in the store of construction materials, or information regarding the selection of intelligent toilets by Consumer A can be entered by the service agent 1, and the collected information can be saved as the historical data of Consumer A to be used as a basis for generating corresponding demand preference when Consumer A visits the store of construction materials next time.

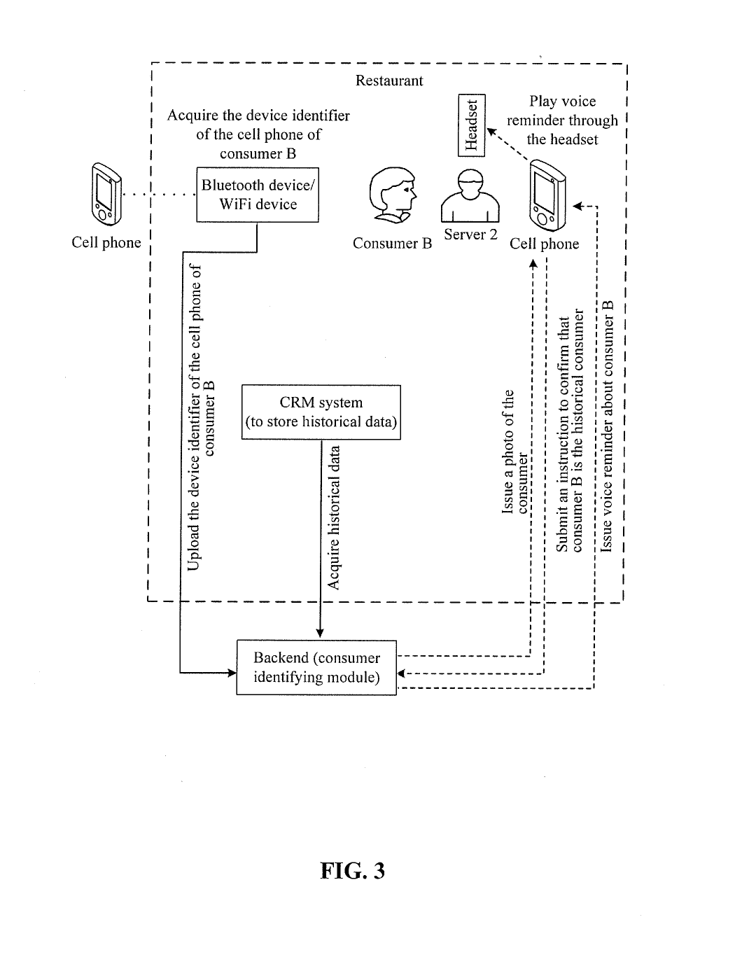

In a second scenario, as shown in FIG. 3, when Consumer B dines at a restaurant, there may be two circumstances when Consumer B walks to the restaurant door. In one circumstance, a smart phone carried by Consumer B automatically connects to a Bluetooth device or WiFi device installed at the restaurant, indicating that the smart phone carried by Consumer B connected to a Bluetooth device or WiFi device installed at the restaurant previously, such that it can be further determined whether Consumer B is a historical consumer of the restaurant. In another circumstance, a smart phone carried by Consumer B is paired with a Bluetooth device or WiFi device installed at the restaurant. If the pairing is successful, the Bluetooth address or device address (device identifier) of the smart phone is acquired, and the acquired Bluetooth address or device address is uploaded to the backend. According to device identifiers of historical consumers contained in the historical data of the restaurant, the backend determines whether the Bluetooth address or device address of the smart phone carried by Consumer B exists in the historical data. If the smart phone carried by Consumer B exists in the historical data, it at least shows the smart phone has visited the restaurant, and then it is further determined whether the historical consumer who visited the restaurant is Consumer B.

After Consumer B enters the restaurant, the CRM system of the restaurant assigns a server 2 to provide services to Consumer B. Subsequently, the backend acquires, from the CRM system, the historical data of the historical consumer corresponding to the smart phone, which includes a consumer photo of the historical consumer. Then, the backend issues the consumer photo of the historical consumer to a cell phone carried by the server 2. The server 2 determines whether the consumer photo of the historical consumer displayed on the cell phone and Consumer B are the same consumer. If the consumer photo corresponds to Consumer B (e.g., the consumer photo is of Consumer B), it is determined that Consumer B is a historical consumer of the restaurant, and an instruction to confirm that Consumer B is the historical consumer is submitted via the cell phone. If the consumer photo does not correspond to Consumer B, Consumer B is determined to be a new consumer. Data related to the dining of the new Consumer B in the restaurant this time is collected, and the collected data is saved as the historical data to be used as a basis for providing high quality services for Consumer B when dining in the restaurant next time.

On the basis of this, if it is determined that Consumer B is a historical consumer of the restaurant, the historical data of Consumer B at the restaurant can be acquired from the CRM system. For example, the historical data includes favorite dish types, favorite seat, dishes ordered last time, favorite chef, and other information of Consumer B. When the historical data of Consumer B at the restaurant is acquired, the historical data of Consumer B can be issued to the cell phone of the server 2, and ultimately reminding information related to the historical data of Consumer B is played via a headset (the headset is connected to the cell phone) on the server 2. Upon learning the historical data of Consumer B, the server 2 can guide Consumer B to the seat that Consumer B liked to sit in the past, and recommend new dishes to Consumer B in a pertinent manner according to favorite dish types, dishes ordered last time, and favorite chef of Consumer B. From the perspective of Consumer B, the dining experience at the restaurant is just like at home.

In summary, in the information system, first characteristic acquiring module 101 acquires the first human physiological characteristic of the store consumer and the second characteristic acquiring module acquires the second human physiological characteristic of the store consumer. Then, consumer identifying module 102 performs accurate identification on the consumer according to the first human physiological characteristic and the second human physiological characteristic, helps the store to provide pertinent services to consumers based on the benchmark identification, improves the consumer service level of the store, and offers high quality service experience to store consumers. Meanwhile, the implementation manner of the information system is simple.

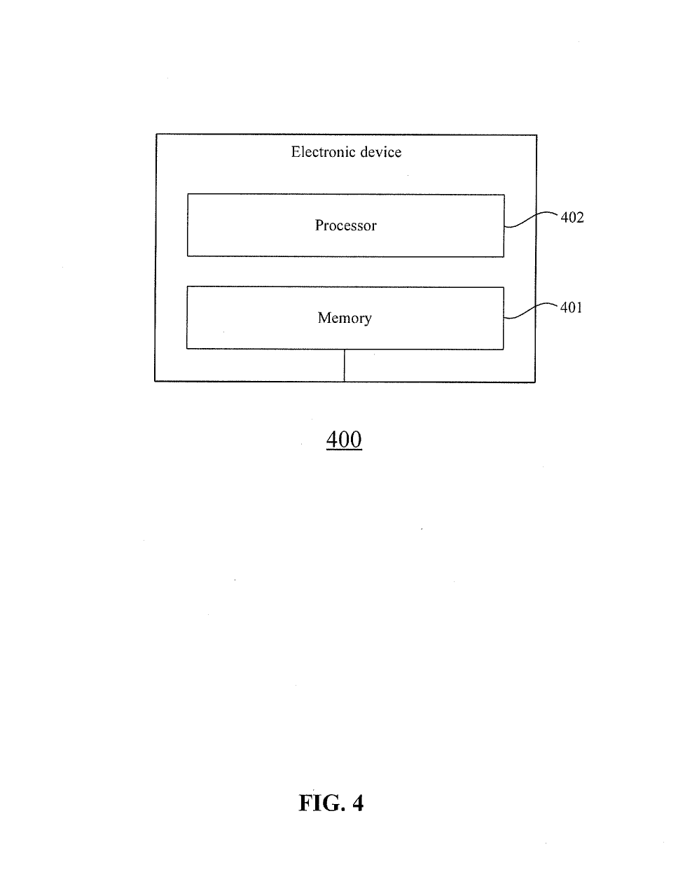

An electronic device according to embodiments of the disclosure is described as follows. FIG. 4 is a schematic diagram of an electronic device 400, according to embodiments of the disclosure.

Electronic device 400 can include: a memory 401, and a processor 402.

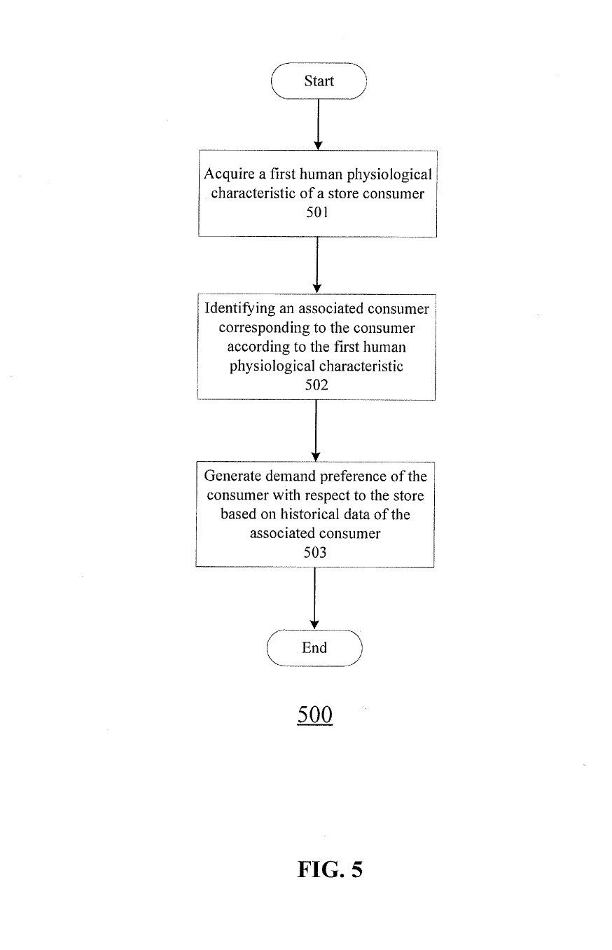

Memory 401 can be configured to store a set of computer executable instructions, and processor 402 can be configured to execute the set of computer executable instructions to cause electronic device 400 to perform a method as shown in FIG. 5. FIG. 5 illustrates a method 500 for generating consumer information, according embodiments of the disclosure. Method 500 can include steps 501-503. Therefore, processor 402 can be configured to execute the set of computer executable instructions to cause electronic device 400 to perform acquiring a first human physiological characteristic of a store consumer (501); identifying an associated consumer corresponding to the consumer according to the first human physiological characteristic (502); and generating demand preference of the consumer with respect to the store based on historical data of the associated consumer (503).

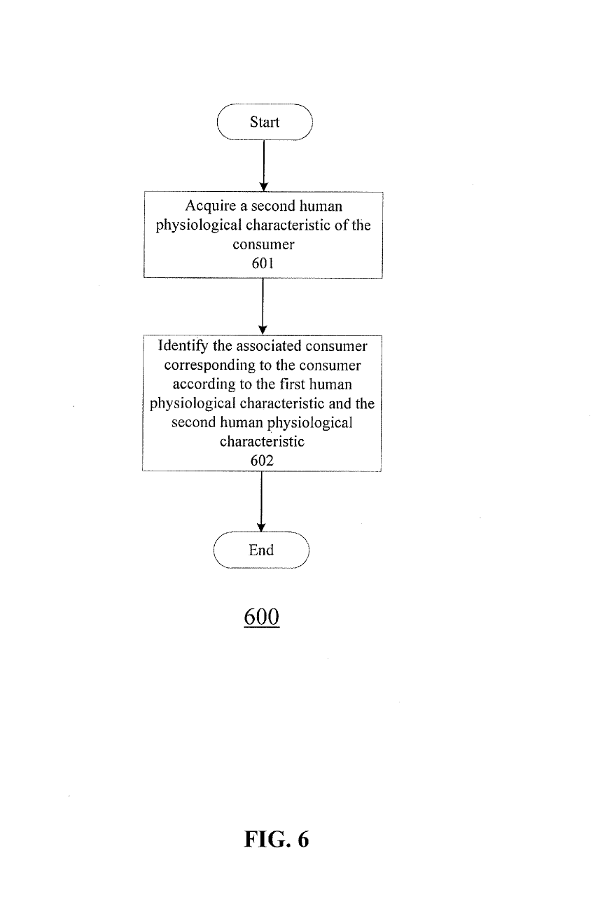

In some embodiments, processor 402 is configured to execute the set of computer executable instructions to further cause electronic device 400 to perform a method as shown in FIG. 6. FIG. 6 illustrates a method 600 for further generating consumer information, according to embodiments of the disclosure. Method 600 can include steps 601-602. Therefore, processor 402 can be configured to execute the set of computer executable instructions to cause electronic device 400 to perform acquiring a second human physiological characteristic of the consumer (601); and identifying the associated consumer corresponding to the consumer according to the first human physiological characteristic and the second human physiological characteristic (602). It is appreciated that processor 402 can perform both methods 500 and 600.

In some embodiments, processor 402 is configured to execute the set of computer executable instructions to further cause electronic device 400 to perform: determining whether the store has a historical consumer having a similarity with the first human physiological characteristic satisfying a similarity threshold, and if so, proceeding to the next step; and determining whether the similarity in the second human physiological characteristic between the consumer and the historical consumer satisfies a similarity threshold, and if so, making the historical consumer a historical consumer corresponding to the consumer at the store, acquiring the historical data of the historical consumer at the store, and generating the demand preference of the consumer with respect to the store based on the historical data.

In some embodiments, processor 402 is configured to execute the set of computer executable instructions to further cause electronic device 400 to perform: detecting a device identifier of a terminal device carried by the consumer.

In some embodiments, processor 402 is configured to execute the set of computer executable instructions to further cause electronic device 400 to perform: identifying a terminal device carried by the historical consumer of the store corresponding to the device identifier, and determining whether the similarity in the second human physiological characteristic between the consumer and the historical consumer satisfies a similarity threshold; if yes, making the historical consumer a historical consumer corresponding to the consumer at the store, acquiring the historical data of the historical consumer at the store, and generating the demand preference of the consumer with respect to the store based on the historical data.

In some embodiments, processor 402 is configured to execute the set of computer executable instructions to further cause electronic device 400 to perform: recommending, according to the demand preference of the consumer with respect to the store generated by the consumer identifying module, a new product service matching the demand preference to the consumer, and/or recommending, according to historical product services contained in the historical data of the associated consumer at the store, a historical product service matching the demand preference to the consumer.

In some embodiments, processor 402 is configured to execute the set of computer executable instructions to further cause electronic device 400 to perform: generating reminding information for the consumer according to the new product service and/or historical product service determined by the recommending unit, as well as the demand preference of the consumer with respect to the store issued by the consumer identifying module; wherein the computer executable instruction for generating reminding information for the consumer according to the new product service and/or historical product service determined by the recommending unit, as well as the demand preference of the consumer with respect to the store issued by the consumer identifying module is executed based on a terminal device carried by service personnel assigned to the consumer, and/or executed based on an audio playing device carried by the service personnel.

In some embodiments, processor 402 is configured to execute the set of computer executable instructions to further cause electronic device 400 to perform: storing the first human physiological characteristic and the second human physiological characteristic of the consumer, as well as the historical data of the historical consumer.

In some embodiments, if a result of executing the instruction for determining whether the store has a historical consumer having a similarity with the first human physiological characteristic satisfying a similarity threshold is that the store does not have a historical consumer having a similarity with the first human physiological characteristic satisfying the similarity threshold, the first human physiological characteristic and/or the second human physiological characteristic of the consumer is stored in the consumer database; and if a result of executing the instruction for determining whether the similarity in the second human physiological characteristic between the consumer and the historical consumer satisfies the similarity threshold is that the store does not have a historical consumer having a similarity with the first human physiological characteristic satisfying the similarity threshold, the first human physiological characteristic and/or the second human physiological characteristic of the consumer is stored in the consumer database.

In some embodiments, processor 402 is configured to execute the set of computer executable instructions to further cause electronic device 400 to perform: acquiring consumer data of the consumer with respect to the store, storing the consumer data in the consumer database, and treating the consumer data as a part of the historical data of the consumer; wherein the instruction for acquiring consumer data of the consumer with respect to the store and storing the consumer data in the consumer database is executed based on a terminal device carried by service personnel assigned to the consumer, and/or the instruction for acquiring consumer data of the consumer with respect to the store and storing the consumer data in the consumer database is executed based on an audio collecting device carried by the service personnel.

In some embodiments, processor 402 is configured to execute the set of computer executable instructions to further cause electronic device 400 to perform: connecting with a consumer relationship management system of the store and acquiring historical data of the historical consumer corresponding to the consumer at the store from the consumer relationship management system.

In some embodiments, the associated consumer comprises at least one of the following: a historical consumer having a similarity in the first human physiological characteristic and the second human physiological characteristic with the consumer satisfying a similarity threshold, a historical consumer having age information and educational background information that are similar to those contained in the historical data of the consumer, a historical consumer having consumption type, consumption credits, consumption points, and consumer consumption rating that are similar to those contained in the historical data of the consumer, a historical consumer having a similarity in the first human physiological characteristic with the consumer satisfying a similarity threshold, and a historical consumer having a similarity in the second human physiological characteristic with the consumer satisfying a similarity threshold.

In some embodiments, the instruction for identifying the historical consumer corresponding to the consumer according to the first human physiological characteristic and the second human physiological characteristic, and generating demand preference of the consumer with respect to the store based on historical data of the historical consumer at the store is executed based on the consumer relationship management system disposed in the store, and/or the instruction for identifying the historical consumer corresponding to the consumer according to the first human physiological characteristic and the second human physiological characteristic, and generating demand preference of the consumer with respect to the store based on historical data of the historical consumer at the store is executed in a cloud computing environment.

In some embodiments, the instruction for acquiring a first human physiological characteristic of a store consumer is executed based on an image collecting apparatus disposed by the store, and/or the instruction for acquiring a second human physiological characteristic of the consumer is executed based on a terminal device carried by service personnel assigned to the consumer.

In some embodiments, the first human physiological characteristic comprises at least one of the following: face characteristics, voiceprint characteristics, gait characteristics, fingerprint characteristics, and physique characteristics.

In some embodiments, the second human physiological characteristic comprises at least one of the following: voiceprint characteristics, iris characteristics, and fingerprint characteristics.

A non-transitory computer readable medium can be provided according to embodiments of the disclosure. The computer readable medium stores a set of instructions that is executable by at least one processor of a computer system to cause the computer system to perform the method described above.

In some embodiments, the set of instructions is executable by at least one processor of a computer system to cause the computer system to further perform: acquire a first human physiological characteristic of a store consumer; and identify an associated consumer corresponding to the consumer according to the first human physiological characteristic and generate demand preference of the consumer with respect to the store based on historical data of the associated consumer.

In some embodiments, the set of instructions is executable by at least one processor of a computer system to cause the computer system to further perform: acquire a second human physiological characteristic of the consumer; and correspondingly, identify the associated consumer corresponding to the consumer according to the first human physiological characteristic and the second human physiological characteristic.

In some embodiments, the set of instructions is executable by at least one processor of a computer system to cause the computer system to further perform: determining whether the store has a historical consumer having a similarity with the first human physiological characteristic satisfying a similarity threshold, and if yes, proceeding to the next step; and determining whether the similarity in the second human physiological characteristic between the consumer and the historical consumer satisfies a similarity threshold, and if yes, making the historical consumer a historical consumer corresponding to the consumer at the store, acquiring the historical data of the historical consumer at the store, and generating the demand preference of the consumer with respect to the store based on the historical data.

In some embodiments, the set of instructions is executable by at least one processor of a computer system to cause the computer system to further perform: detecting a device identifier of a terminal device carried by the consumer.

In some embodiments, the set of instructions is executable by at least one processor of a computer system to cause the computer system to further perform: identifying a terminal device carried by the historical consumer of the store corresponding to the device identifier, and determining whether the similarity in the second human physiological characteristic between the consumer and the historical consumer satisfies a similarity threshold; if yes, making the historical consumer a historical consumer corresponding to the consumer at the store, acquiring the historical data of the historical consumer at the store, and generating the demand preference of the consumer with respect to the store based on the historical data.

In some embodiments, the set of instructions is executable by at least one processor of a computer system to cause the computer system to further perform: recommending, according to the demand preference of the consumer with respect to the store generated by the consumer identifying module, a new product service matching the demand preference to the consumer, and/or recommend, according to historical product services contained in the historical data of the associated consumer at the store, a historical product service matching the demand preference to the consumer.

In some embodiments, the set of instructions is executable by at least one processor of a computer system to cause the computer system to further perform: generating reminding information for the consumer according to the new product service and/or historical product service determined by the recommending unit, as well as the demand preference of the consumer with respect to the store issued by the consumer identifying module; wherein the computer executable instruction for generating reminding information for the consumer according to the new product service and/or historical product service determined by the recommending unit, as well as the demand preference of the consumer with respect to the store issued by the consumer identifying module is executed based on a terminal device carried by service personnel assigned to the consumer, and/or executed based on an audio playing device carried by the service personnel.

In some embodiments, the set of instructions is executable by at least one processor of a computer system to cause the computer system to further perform: storing the first human physiological characteristic and the second human physiological characteristic of the consumer, as well as the historical data of the historical consumer.

In some embodiments, if a result of executing the instruction for determining whether the store has a historical consumer having a similarity with the first human physiological characteristic satisfying a similarity threshold is that the store does not have a historical consumer having a similarity with the first human physiological characteristic satisfying the similarity threshold, the first human physiological characteristic and/or the second human physiological characteristic of the consumer is stored in the consumer database; and if a result of executing the instruction for determining whether the similarity in the second human physiological characteristic between the consumer and the historical consumer satisfies the similarity threshold is that the store does not have a historical consumer having a similarity with the first human physiological characteristic satisfying the similarity threshold, the first human physiological characteristic and/or the second human physiological characteristic of the consumer is stored in the consumer database.

In some embodiments, the set of instructions is executable by at least one processor of a computer system to cause the computer system to further perform: acquiring consumer data of the consumer with respect to the store, store the consumer data in the consumer database, and treat the consumer data as a part of the historical data of the consumer; wherein the instruction for acquiring consumer data of the consumer with respect to the store and storing the consumer data in the consumer database is executed based on a terminal device carried by service personnel assigned to the consumer, and/or the instruction for acquiring consumer data of the consumer with respect to the store and storing the consumer data in the consumer database is executed based on an audio collecting device carried by the service personnel.

In some embodiments, the set of instructions is executable by at least one processor of a computer system to cause the computer system to further perform: connecting with a consumer relationship management system of the store and acquire historical data of the historical consumer corresponding to the consumer at the store from the consumer relationship management system.

In some embodiments, the associated consumer comprises at least one of the following: a historical consumer having a similarity in the first human physiological characteristic and the second human physiological characteristic with the consumer satisfying a similarity threshold, a historical consumer having age information and educational background information that are similar to those contained in the historical data of the consumer, a historical consumer having consumption type, consumption credits, consumption points, and consumer consumption rating that are similar to those contained in the historical data of the consumer, a historical consumer having a similarity in the first human physiological characteristic with the consumer satisfying a similarity threshold, and a historical consumer having a similarity in the second human physiological characteristic with the consumer satisfying a similarity threshold.

In some embodiments, the instruction for identifying the historical consumer corresponding to the consumer according to the first human physiological characteristic and the second human physiological characteristic, and generating demand preference of the consumer with respect to the store based on historical data of the historical consumer at the store is executed based on the consumer relationship management system disposed in the store, and/or the instruction for identifying the historical consumer corresponding to the consumer according to the first human physiological characteristic and the second human physiological characteristic, and generating demand preference of the consumer with respect to the store based on historical data of the historical consumer at the store is executed in a cloud computing environment.

In some embodiments, the instruction for acquiring a first human physiological characteristic of a store consumer is executed based on an image collecting apparatus disposed by the store, and/or the instruction for acquiring a second human physiological characteristic of the consumer is executed based on a terminal device carried by service personnel assigned to the consumer.

In some embodiments, the first human physiological characteristic comprises at least one of the following: face characteristics, voiceprint characteristics, gait characteristics, fingerprint characteristics, and physique characteristics.

In some embodiments, the second human physiological characteristic comprises at least one of the following: voiceprint characteristics, iris characteristics, and fingerprint characteristics.

The present application has been disclosed via preferred embodiments as above, which, however, are not used to limit the present application. Any person skilled in the art may make possible variations and modifications without departing from the spirit and scope of the present application. Therefore, the scope of the present application shall be subject to the scope defined by the claims of the present application.

In a typical configuration, the computation device includes one or more processors (CPUs), input/output interfaces, network interfaces, and a memory.

The memory may include computer readable media, such as a volatile memory, a Random Access Memory (RAM), and/or a non-volatile memory, e.g., a Read-Only Memory (ROM) or a flash RAM. The memory is an example of a computer readable medium.

Computer readable media include permanent, volatile, mobile and immobile media, which can implement information storage through any method or technology. The information may be computer readable instructions, data structures, program modules or other data. Examples of storage media of computers include, but are not limited to, Phase-change RAMs (PRAMs), Static RAMs (SRAMs), Dynamic RAMs (DRAMs), other types of Random Access Memories (RAMs), Read-Only Memories (ROMs), Electrically Erasable Programmable Read-Only Memories (EEPROMs), flash memories or other memory technologies, Compact Disk Read-Only Memories (CD-ROMs), Digital Versatile Discs (DVDs) or other optical memories, cassettes, cassette and disk memories or other magnetic memory devices or any other non-transmission media, which can be used for storing information accessible to a computation device. According to the definitions herein, the computer readable media do not include transitory media, such as modulated data signals and carriers.

A person skilled in the art should understand that the embodiments of the disclosure may be provided as a method, a system, or a computer program product. Therefore, the embodiments of the disclosure may be implemented as a complete hardware embodiment, a complete software embodiment, or an embodiment combing software and hardware. Moreover, the present application may be in the form of a computer program product implemented on one or more computer usable storage media (including, but not limited to, a magnetic disk memory, CD-ROM, an optical memory, and the like) comprising computer usable program codes therein.

1. An information system, comprising:
a memory storing a set of instructions; and
at least one processor, configured to execute the set of instructions to cause the system to perform
acquiring a first human physiological characteristic of a store consumer;
generating at least one associated consumer corresponding to the store consumer based on the first human physiological characteristic; and
generating demand preference for the consumer based on historical data of the at least one associated consumer.

2-10. (canceled)

11. A method for generating information of a store consumer, comprising:
acquiring a first human physiological characteristic of the store consumer;
generating at least one associated consumer corresponding to the store consumer based on the first human physiological characteristic; and
generating demand preference for the consumer based on historical data of the at least one associated consumer.

12. The method according to claim 11, further comprising:
acquiring a second human physiological characteristic of the store consumer; and
generating an associated consumer corresponding to the store consumer based on the first human physiological characteristic and the second human physiological characteristic.

13. The method according to claim 12, wherein generating the demand preference for the consumer based on the historical data of the at least one associated consumer further comprises:
determining whether the store has a historical consumer having a first similarity with the first human physiological characteristic satisfying a first similarity threshold;
in response to the determination that the first similarity threshold being satisfied, determining whether the historical consumer has a second similarity with the second human physiological characteristic satisfying a second similarity threshold;
in response to the determination that the second similarity threshold being satisfied, determining the historical consumer as the associated consumer;
acquiring historical data of the historical consumer; and
generating the demand preference of the store consumer based on the historical data.

14. The method according to claim 11, further comprising:
detecting a device identifier of a terminal device carried by the store consumer; and
identifying the terminal device carried based on the device identifier.

15. The method according to claim 11, further comprising:
recommending, according to the demand preference of the associated consumer, a new product service; or
recommending, according to historical data of the associated consumer, a historical product service.

16. The method according to claim 15, further comprising:
generating reminding information for the store consumer according to the new product service or the historical product service.

17. The method according to claim 13, further comprising:
in response to the determination that the first similarity satisfying the first similarity threshold, storing the first human physiological characteristic in a consumer database; and
in response to the determination that the second similarity threshold being satisfied, storing the second human physiological characteristic in the consumer database.

18. The method according to claim 17, further comprising:
acquiring consumer data of the store consumer; and
storing the consumer data in the consumer database as the historical data of the store consumer.

19. The method according to claim 12, wherein the at least one associated consumer comprises at least one of:
a historical consumer having a first similarity satisfying the first similarity threshold or a second similarity satisfying the second similarity threshold,
a historical consumer having age information and educational background information that are similar to those contained in the historical data of the consumer, and
a historical consumer having consumption type, consumption credits, consumption points, and consumer consumption rating that are similar to those contained in the historical data of the consumer.

20. The method according to claim 11, wherein
the first human physiological characteristic comprises at least one of face characteristics, voiceprint characteristics, gait characteristics, fingerprint characteristics, and physique characteristics, and
the second human physiological characteristic comprises at least one of voiceprint characteristics, iris characteristics, and fingerprint characteristics.

21. A non-transitory computer readable medium that stores a set of instructions that is executable by at least one processor of a computer system to cause the computer system to perform a method for generating information of a store consumer, the method comprising:
acquiring a first human physiological characteristic of the store consumer;
generating at least one associated consumers corresponding to the store consumer based on the first human physiological characteristic; and
generating demand preference for the consumer based on historical data of the at least one associated consumer.

22. The non-transitory computer readable medium according to claim 21, wherein the set of instructions is executable by the at least one processor to cause the computer system to further perform:
acquiring a second human physiological characteristic of the store consumer; and
generating an associated consumer corresponding to the store consumer based on the first human physiological characteristic and the second human physiological characteristic.

23. The non-transitory computer readable medium according to claim 22, wherein the set of instructions is executable by the at least one processor to cause the computer system to further perform:
determining whether the store has a historical consumer having a first similarity with the first human physiological characteristic satisfying a first similarity threshold;
in response to the determination that the first similarity satisfying the first similarity threshold, determining whether the historical consumer has a second similarity with the second human physiological characteristic satisfying a second similarity threshold;
in response to the determination that the second similarity satisfying the second similarity threshold, determining the historical consumer as the associated consumer;
acquiring historical data of the historical consumer; and
generating the demand preference of the store consumer based on the historical data.

24. The non-transitory computer readable medium according to claim 21, wherein the set of instructions is executable by the at least one processor to cause the computer system to further perform:
detecting a device identifier of a terminal device carried by the store consumer; and
identifying the terminal device carried based on the device identifier.

25. The non-transitory computer readable medium according to any claim 21, wherein the set of instructions is executable by the at least one processor to cause the computer system to further perform:
recommending, according to the demand preference of the associated consumer, a new product service; or
recommending, according to historical data of the associated consumer, a historical product service.

26. The non-transitory computer readable medium according to claim 25, wherein the set of instructions is executable by the at least one processor to cause the computer system to further perform:
generating reminding information for the store consumer according to the new product service or the historical product service.

27. The non-transitory computer readable medium according to claim 23, wherein the set of instructions is executable by the at least one processor to cause the computer system to further perform:
in response to the determination that the first similarity satisfying the first similarity threshold, storing the first human physiological characteristic in a consumer database; and
in response to the determination that the second similarity satisfying the second similarity threshold, storing the second human physiological characteristic in the consumer database.

28. The non-transitory computer readable medium according to claim 27, wherein the set of instructions is executable by the at least one processor to cause the computer system to further perform:
acquiring consumer data of the store consumer; and
storing the consumer data in the consumer database as the historical data of the store consumer.

29. The non-transitory computer readable medium according to claim 22, wherein the at least one associated consumer comprises at least one of:
a historical consumer having a first similarity satisfying the first similarity threshold or a second similarity satisfying the second similarity threshold,
a historical consumer having age information and educational background information that are similar to those contained in the historical data of the consumer, and
a historical consumer having consumption type, consumption credits, consumption points, and consumer consumption rating that are similar to those contained in the historical data of the consumer.

30. The non-transitory computer readable medium according to claim 21, wherein
the first human physiological characteristic comprises at least one of face characteristics, voiceprint characteristics, gait characteristics, fingerprint characteristics, and physique characteristics, and
the second human physiological characteristic comprises at least one of voiceprint characteristics, iris characteristics, and fingerprint characteristics.
